(19) United States
(12) Patent Application Publication
(10) Pub. No.: US 2010/0301638 A1
(43) Pub. Date: Dec. 2, 2010

(54) Integrated Air Intake System

(76) Inventors: Eric J. Hinshaw, Geneseo, IL (US); Kevin G. Braun, Dubuque, IA (US)

Correspondence Address: DEERE & COMPANY, ONE JOHN DEERE PLACE, MOLINE, IL, 61265, US

(21) Appl. No.: 12/718,167

(22) Filed: Mar. 5, 2010

Related U.S. Application Data
(60) Provisional application No. 61/182,420, filed on May 29, 2009.

(51) Int. Cl. B60R 99/00

(52) U.S. Cl. 296/208

(57) ABSTRACT

An engine air intake system is provided which is formed by an engine compartment. A fan and a grille screen are used to remove a portion of debris from air external to the vehicle. After the air is partially cleaned via the grille screen, it moves toward a heat exchanger carrying a portion of the remaining debris with it. A portion of the debris may fall out of the air via gravitational effects. A portion of the air then moves up and into an entrance passage for an air intake duct that is integrated with the hood of the engine enclosure, this portion having been further cleaned via debris passage to and through the heat exchanger as well as gravitational effects. The air then travels through the air intake duct and passes through an air filter where a portion of the remaining debris is removed prior to the air being supplied to the engine intake.

### CROSS REFERENCE TO RELATED APPLICATIONS

This is a non-provisional application based upon U.S. provisional patent application Ser. No. 61/182,420, entitled “INTEGRATED AIR INTAKE SYSTEM”, filed May 29, 2009.

### FIELD OF THE INVENTION

The invention relates to the structure and operation of air intake systems and methods of supplying intake air to internal combustion engines. More specifically, it relates to a method, system and structure for supplying ambient or non-preheated air to an internal combustion engine for a work vehicle or mobile construction machine such as, for example, a wheeled feller buncher.

### BACKGROUND OF THE INVENTION

Most mobile construction machines employ above-hood engine air intakes. The above-hood air intake is usually covered by a shield to prevent the entrance of rain and other precipitation. Above-hood air intakes are typically designed to be low-profile, i.e., have as small of a visual signature as possible. However, these intakes are required to be high enough to minimize the entry of dust and other debris settling near the hood and far enough from the exhaust stack associated with these machines to minimize the intake of preheated air. Pre-cleaners are typically used in above-hood air intake designs to remove some of the debris from the intake air and, thereby, extend engine air filter life.

As previously indicated, conventional above-hood air intake systems for work vehicles tend to obstruct visibility for the work vehicle operator. This is a consequence of attempting to meet the noted demands of locating the air intake (1) high enough to eliminate or minimize the entry of dust and debris from the hood and (2) far enough from the exhaust stack to eliminate or minimize the intake of preheated air. These disadvantages are only intensified by the relatively large pre-cleaners that are often attached to the entry point of such systems in high debris environments.

Some mobile construction machines are provided with conventional under hood air intake systems having air intake tubes with inlet openings located in the engine compartment. When these systems have perforations in the hood of the engine compartment, the inlet opening is arranged to prevent the intake of rain and other precipitation. Thus, the inlet opening of the air intake is angled such that the intake air enters in a direction that is horizontal to or at least partially opposite to the direction of the precipitation as it enters the engine compartment. Other under hood air intake designs include air intake tubes that are routed to compact cooling package areas where the air inlets are located in areas separate from the engine compartment.

A major disadvantage of many conventional under hood air intake systems where the intake port is located in the engine compartment is that they tend to intake preheated air via convection and radiation with respect to the engine. This is accentuated when these systems have perforations in the hood as the intake port must be angled away from the perforations and more toward the engine compartment with air preheated by heat exchanger(s) and the engine. Other under hood air intake designs tend to avoid this problem but all under hood designs tend to use only screens and filters to remove debris as the use of pre-cleaners under the hood tends to: (1) take up too much precious space, i.e., premium space; and (2) the inconvenience caused by the debris typically ejected by such devices.

### SUMMARY OF THE INVENTION

The invention overcomes each of the above disadvantages by providing an air intake system integral to and formed by a hood of an engine enclosure as well as other conventional components within the engine enclosure. The engine enclosure is formed by at least the hood, two sidewalls, a grille and a screen. An insulated air duct forms an integral part of the hood and is in communication with a filter for engine air intake. The air entering the air duct may be moved into the engine enclosure via a fan for the purpose of moving air from the ambient surroundings outside of the vehicle to a location inside the vehicle and, typically, through a heat exchanger. The air may also be pre-cleaned by a screen as well as relative movement between debris and air prior to and after pre-cleaning of the air by the screen. The entrance to the air duct is preferably located such that the ambient air entering the air channel tends toward ambient temperature, i.e., air that has not been preheated via passage through the heat exchanger. Thus, a preferable location for the entrance to the air duct is, horizontally, between the screen and the heat exchanger and, vertically, toward the top of the screen and the heat exchanger. Further, the entrance passage is preferably substantially orthogonal to the axis of the fan or at an angle greater than 90 degrees to the axis of the fan or the flow direction of the air. Such an arrangement gives the air a chance for a first pre-cleaning via the screen as well as a second pre-cleaning via the general inability of debris to change direction and move upwards and into the entrance passage to the same extent as air.

### BRIEF DESCRIPTION OF THE DRAWINGS

Embodiments of the invention will be described in full detail with references to the following Figures, wherein:

FIG. 1 is a view of a work vehicle in which the invention is used;

FIG. 2 is an oblique view of a rear portion of the vehicle illustrated in FIG. 1;

FIG. 3 is an oblique cutaway view of the engine enclosure showing a view of an exemplary air intake system;

FIG. 4 is an oblique cutaway view showing the exemplary air intake system of FIG. 3 illustrating a connection between the filter and a turbocharger;

FIG. 5 is a side view cutaway of a portion of the air intake system of FIGS. 3 and 4 illustrating a bolted connection between the screen and the grille of the vehicle of FIG. 1, a sealed assembly between first and second portions of the air channel, and an entrance passage to the air channel;

FIG. 6 is a close-up view of a portion of FIG. 5

FIG. 7 is a rear view cutaway of a cylinder through the air channel for easy access to a fill cap for the heat exchanger;

FIG. 8 is a forward cutaway of the engine enclosure showing the interface between the air filter duct and the air intake duct;

FIG. 9 is a view of first air intake duct portion isolated; and

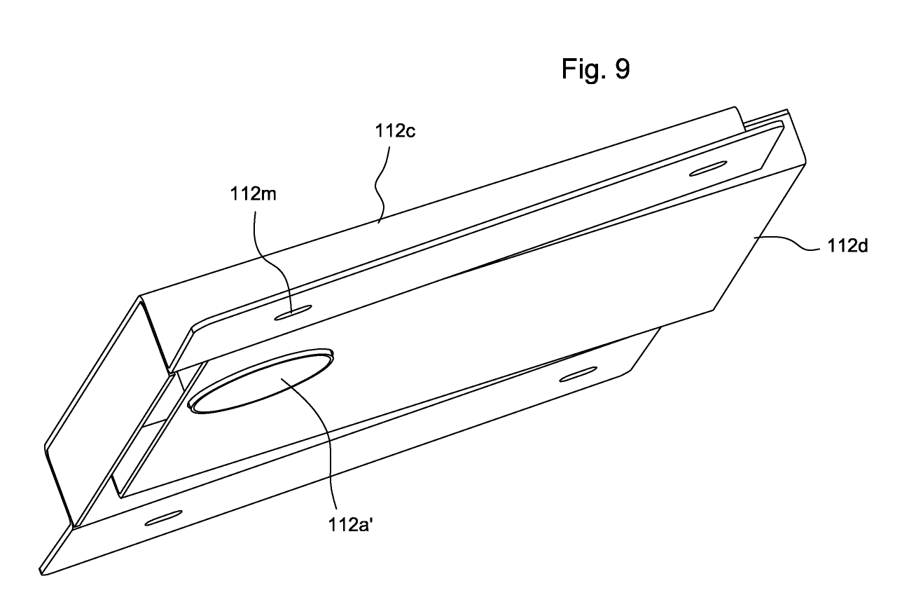

FIG. 10 is a view of the second air intake duct portion isolated.

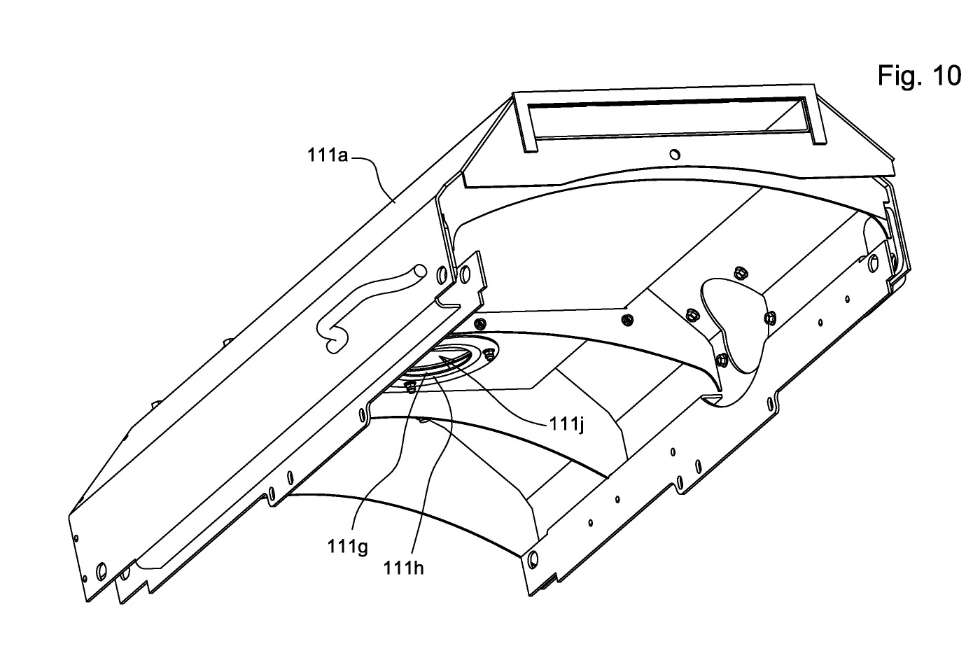

### DESCRIPTION OF THE PREFERRED EMBODIMENT

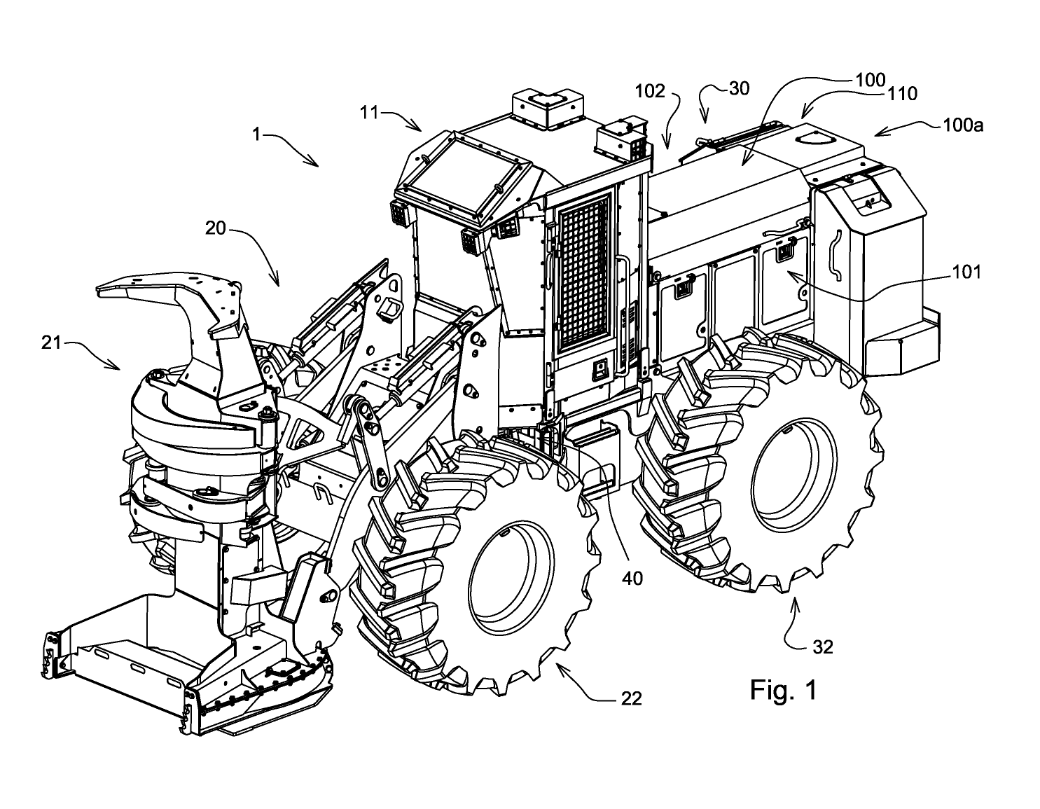

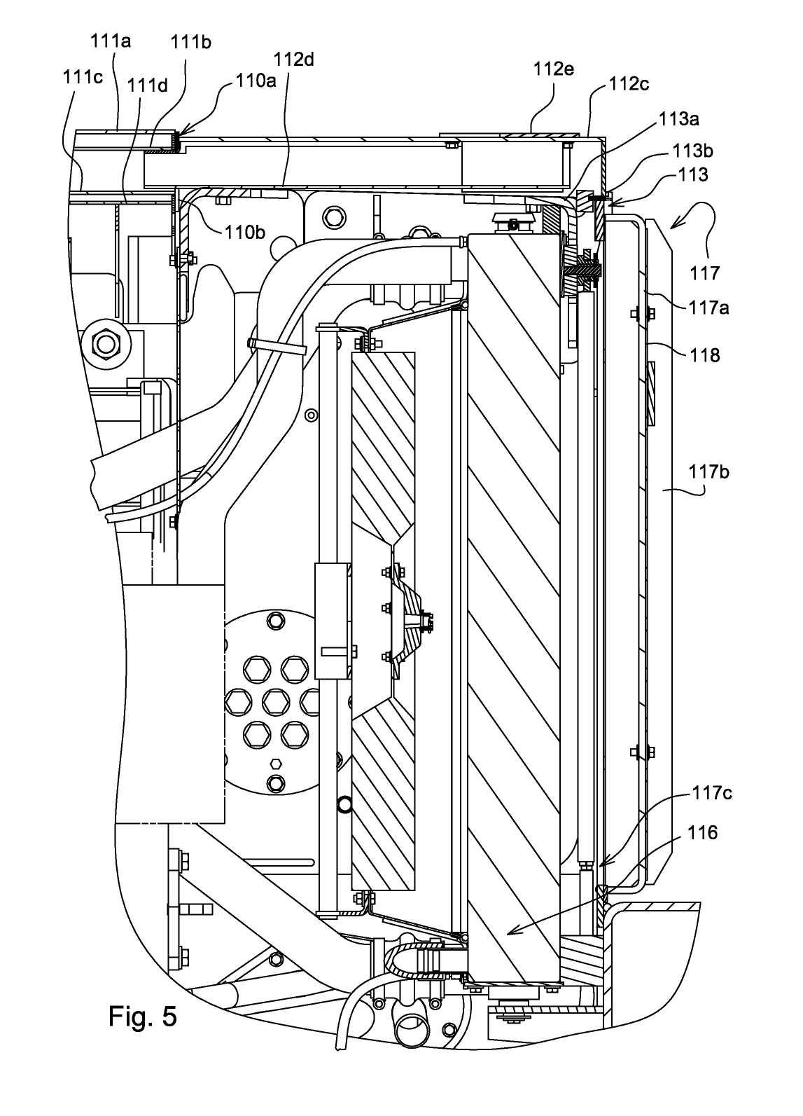

FIG. 1 illustrates an exemplary embodiment of a work vehicle in which the invention is used. The particular work vehicle illustrated in FIG. 1 is a wheeled feller buncher 1; an articulated vehicle having a front body portion 20 connected to a rear body portion 30 via pivots 40, the wheeled feller buncher 1 being steered by pivoting of the front body portion 20 relative to the rear body portion 30 in a manner well known in the art. The rear body portion 30 includes an engine enclosure 100 having a first sidewall 101, a second sidewall 102 and a hood 100a with an integrated air intake duct 110 and a supporting structure 113 (FIG. 5).

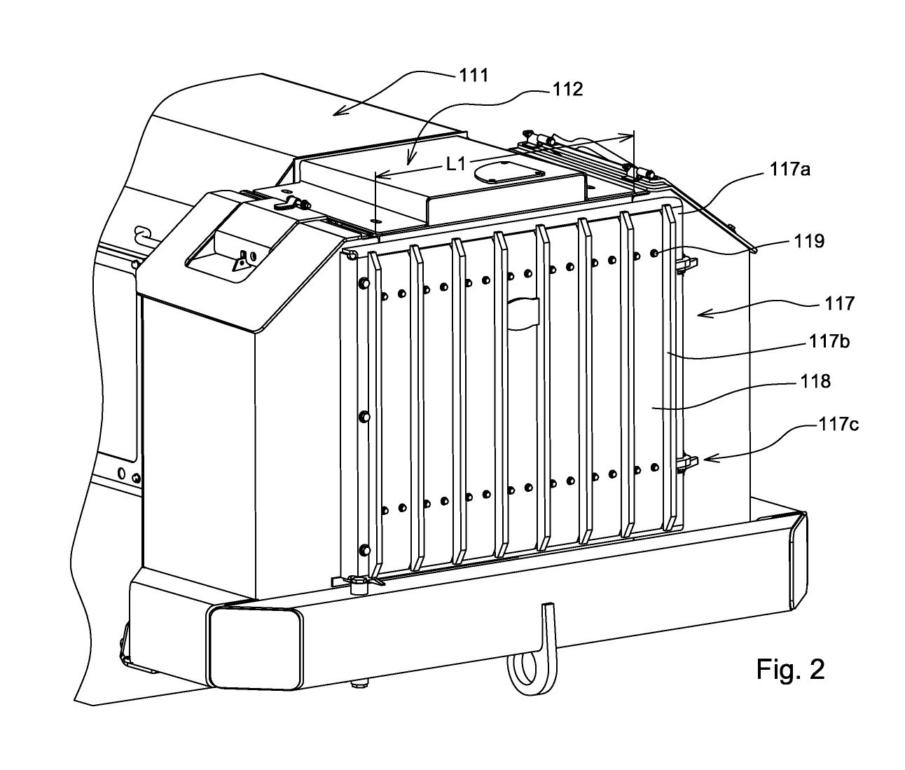

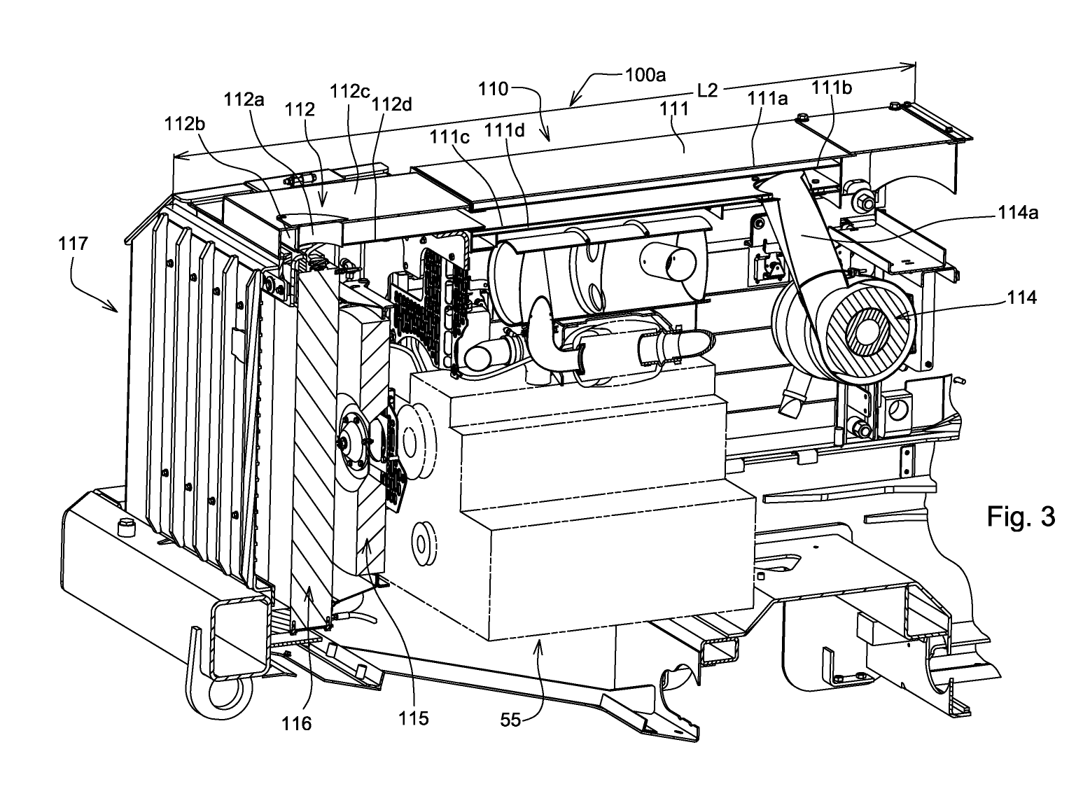

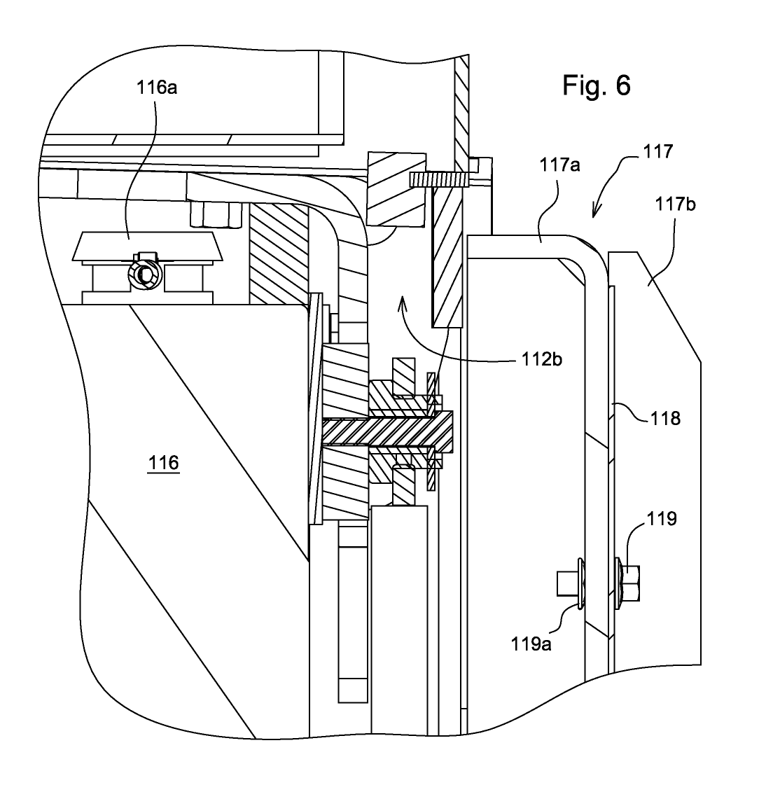

FIGS. 2 and 3 illustrate that, in this exemplary embodiment, a grille screen 117 forms a portion of the engine enclosure 100. As shown in FIGS. 5 and 6, in this particular embodiment, the grille screen 117 includes a grille bar support 117a, a plurality of grille bars 117b and a screen 118 with a multiplicity of holes, each having an approximate diameter of 2.5 mm. Each grille bar 117b is, in this embodiment, welded to the grille bar support 117a. The grille screen is assembled by locating the screen 118 between the grille bar support 117a and the plurality of grille bars 117b as shown in FIGS. 5 and 6 and attaching it to the grille bar support 117a via a plurality of fasteners such as, for example, the bolt 119 and welded nut 119a arrangement shown in FIGS. 5 and 6. The grille screen 117 acts as a door for the engine enclosure 100; it is pivotally connected to a hinge 117c and swings outwardly and away from the vehicle in a manner well known in the art. The grille bar support 117a and the plurality of grille bars 117b, among other things, serve a decorative function and act as a support and protective structure for the screen 118.

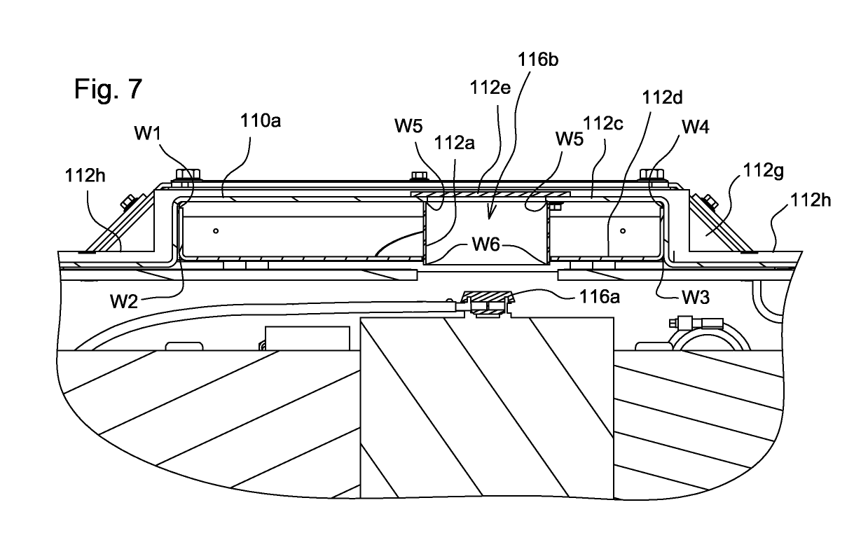

FIG. 3 also shows the intake air duct 110 which, in this embodiment, extends along a significant portion of the length L of the hood 100a as well as a significant portion of the width W of the hood 100a. As illustrated in FIG. 3, the air intake duct 110 is an assembly including a first intake air duct portion 112 and a second intake air duct portion 111. As illustrated in FIG. 7, the first air intake duct portion 112 is formed by two channels, including; a lower channel 112d and an upper channel 112c forming a rear outer shell of the hood, i.e., a rear hood cover 112g with flanges 112h. The lower and upper channels 112d and 112c are welded along their lengths at W1, W2, W3 and W4. As shown in FIGS. 3 and 5, a rectangular opening toward the rear end of the first air intake duct portion 112 forms a part of an air entrance passage 112b which allows air to enter the air intake duct 110 in a direction that is generally orthogonal to the flow of air between the grille screen 117 and the heat exchanger 116. An air guidance structure 113 completes the air entrance passage 112b. The air guidance structure is welded to the frame of the vehicle in a well known manner. Seals 113a, 113b are provided between the first air intake duct portion 112 and the air guidance structure 113 to provide a barrier to leakage of air into or out of the entrance passage 112b as air from the air guidance structure 113 moves into the first intake air duct portion 112.

Welded to each channel and vertical thereto is a cylinder 112a providing an access hole 116b to a fill cap 116a of the heat exchanger 116. The cylinder 112a is welded along its circumference at each end to the upper and lower channels 112c, 112d at W5 and W6.

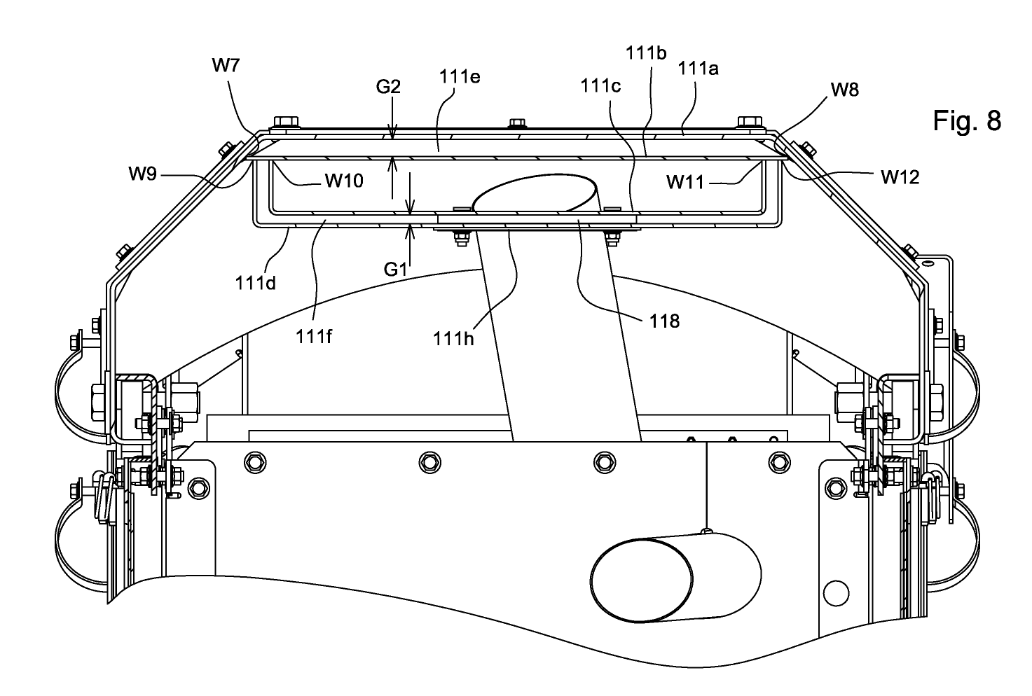

As illustrated in FIGS. 1 and 8, the second air intake duct portion 111 is formed via first and second forward channels 111c, 111d and a supporting structure which is formed by a plate 111b welded along its length, at W7 and W8 to the internal side of a hood shell, i.e., forward hood structure 111a which is, in this case, of trapezoidal shape cross sectionally. As shown in FIG. 8, the ends of the first and second forward channels 111c, 111d are attached to the plate 111b via weldments along their lengths at W9, W10, W11 and W12 as illustrated. As illustrated a gap 111f is formed between the first and second forward channels 111c, 111d. The width G1 of the first gap 111f and the substantially static air therein provide insulation, i.e., a barrier to the transfer of heat from inside the engine enclosure 100. As shown in FIG. 8 a second gap 111e is formed between the plate 111b and the hood structure 111a. The width G2 of the second gap 111e as well as the static air therein provide insulation, i.e., a barrier to the transfer of heat between the outside ambient air and the air passing through the second air intake duct portion 111. In this exemplary embodiment, G1 is approximately 19 mm and G2 is approximately 22 mm. The width of the air intake duct 110 and the gap widths internal to the air intake duct 110 providing the insulation are designed to optimize air flow within the intake air duct 110 while maintaining improved visibility for the operator, i.e., a low hood profile. The pressure for optimal flow varies with configuration but, is, in this exemplary embodiment, approximately 3.3 kPa. This value is subject to change with changes in the configuration and desired performance demands from the overall design.

The rear hood cover 112g of the first air intake duct portion 112 and the forward hood structure 111a of the second air intake duct portion 111 are bolted to the frame in a manner well known in the art. As illustrated in FIG. 5, the lower channel 112d is longer than the upper channel 112c. As illustrated in FIGS. 5, 7 and 8, upon assembly of the first air intake duct 112 to the second air intake duct portion 111, the upper channel 112c butts up against a seal 110a to prevent debris and water from the external environment from entering the air intake duct 110 at the interface between the first air intake duct portion 112 and the second air intake duct portion 111. As illustrated in FIG. 5, the lower channel 112d slides into the second air intake duct portion 111. A seal 110b is also provided to prevent leakage of air into and out of the air intake duct 110 at the interface between the first air intake duct portion 111 and the second air intake portion 112; this seal 110b provides a barrier to air flow between air in the engine enclosure 100 and the air intake duct 110. Both of the seals 110a, 110b are, in this exemplary embodiment, attached to the second air intake duct portion in a manner well known in the art. A labyrinth pattern at the forward end of the upper channel 112c provides extra sealing against external moisture and debris.

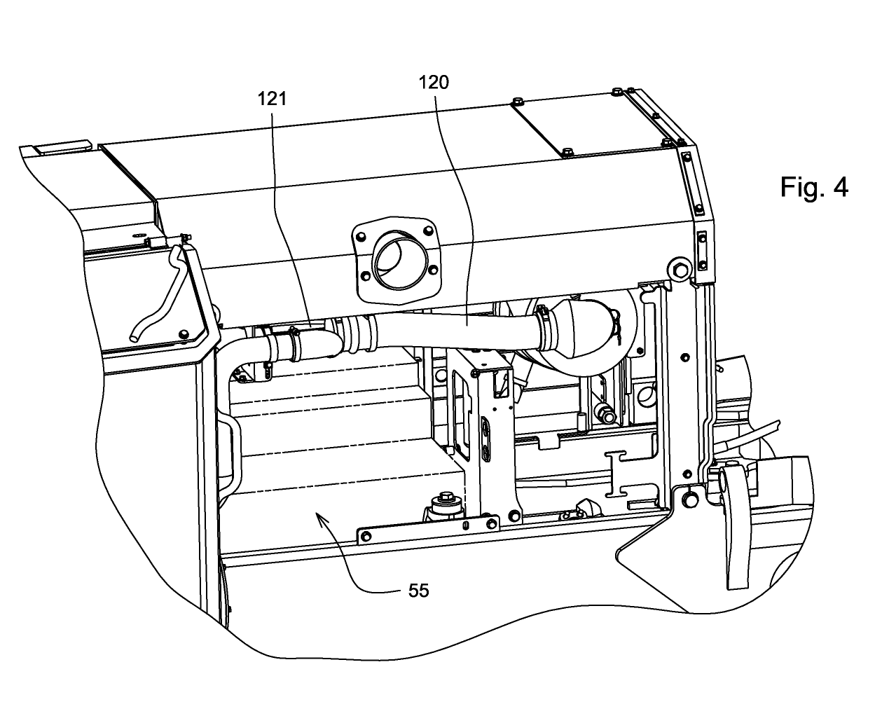

As illustrated in FIGS. 3 and 8, a sealed opening 111j is provided for a first air filter duct 114a toward the forward end of the second air intake duct portion 111. The sealed opening is provided by a cylinder 111g welded toward its ends to bottom portions of the first and second forward channels 111c, 111d. Holes, in this exemplary embodiment, are provided in the first and second forward channels 111c, 111d to allow for passage of the air filter intake duct 114a into the second air intake duct 111. A fifth seal 111h is attached to the outside surface of second forward channel 111d in a manner well known in the art to prevent leakage of air at the interface of the second air intake duct portion 111 and the air filter duct intake 114a as air flows from the second air intake duct portion 111 into the air filter intake duct 114a and eventually to the air filter 114 to which the air filter intake duct is attached. As shown in FIGS. 3 and 4, the air filter 114 is attached to the frame in a manner well known in the art, e.g., straps 114b.

As illustrated, an air filter supply duct 120 provides communication between the air filter 114 and a turbocharger 121. An engine 55 operates in conjunction with the turbocharger 121 in a manner well known in the art. As the engine operates, the heat and pressure of the exhaust gas passes to the turbocharger 121 which lowers the pressure in the supply duct and, thereby, lowers the pressure in the air filter 114, the air filter intake duct 114a and the air intake duct 110. The lower pressure in the air intake duct 110 causes the flow of air into the air entrance passage 112b.

In operation, the fan 115 draws outside air, i.e., a first ambient air through the grille screen 117. As the air passes through the grille screen 117, the screen blocks the passage of larger debris, allowing only debris that may pass through the holes 118a provided in the screen. This results in a second ambient air, i.e., air from which a portion of debris has been removed via the screen 118. As the second ambient air moves toward the heat exchanger 116 other debris tends to move along with it or to fall out of it via gravitational effects. Demands of the engine, communicated via the turbocharger, cause a portion of the air between the screen 118 and the heat exchanger 116 to flow into the entrance passage 112b. The air flowing into the entrance passage 112b constitutes a third ambient air as some debris has been removed from it via the above gravitational effects and the passage of some debris to and through the heat exchanger. Some of the remaining debris lacks sufficient ability to turn upwards and move into the entrance passage 112b to the same extent as air.

Third ambient air, upon moving into the first air intake duct portion 112 must make a sharp turn as the entrance passage 112b is, in this exemplary embodiment, orthogonal to the air intake duct 110. Some additional debris may drop out and be removed at this point. The third ambient air passes through the air intake duct 110 and into the air filter 114 via the air filter intake duct 114a. The filter 114 then removes another portion of the debris and the air emerging from the filter enters the filter supply duct 120. The air entering the filter supply duct 120 is a fourth ambient air, i.e., third ambient air with a portion of the debris removed by the filter 114. The fourth ambient air is then supplied to the turbocharger via the filter supply duct 120 and then supplied to the engine 55 via the turbocharger 121 in a manner well known in the art.

Having described the preferred embodiment, it will become apparent that various modifications can be made without departing from the scope of the invention as defined in the accompanying claims. For example, an air intake duct may be constructed and insulated using several alternative methods. Some of these methods might include: (1) forming a second air intake portion by using fully formed inner and outer ducts; (2) providing heat insulation for both portions of an air intake duct; (3) making an air intake duct a single piece; (4) locating the air intake duct at an angle greater or less than that of the hood; (5) locating a fan and heat exchanger at a level that is lower than that of the screen. The plates, channels and hood covers of this particular embodiment are metallic but could, conceivably, be formed from other materials of high strength or low conductivity, etc. Other variations of materials, arrangement and construction would apply to the air duct as well as any other portion of the invention described herein.

The invention claimed is:

1. An air intake system for a vehicle comprising:
an engine enclosure, the engine enclosure comprising a hood and at least one side wall;
an engine;
a heat exchanger;
a screen;
a filter;
a filter supply duct; and
a fan, the hood including an air intake duct along a length of the hood, the air channel integral to the hood and supplying intake air for the engine, the air intake duct having an entrance passage providing for air flow in a direction substantially orthogonal to a direction of the air intake duct, the entrance passage longitudinally located between the screen and the heat exchanger, the fan moving a first ambient air through the screen and a second ambient air into the engine enclosure, the fan moving the second ambient air through the heat exchanger, the engine moving a third ambient air through the entrance passage and into the air intake duct via an air intake duct pressure lower than a pressure of the second ambient air, the engine moving the third ambient air through the filter via a pressure in the filter supply duct to provide a fourth ambient air.

2. The air intake system of claim 1, wherein the first ambient air is air outside of the engine enclosure containing a first amount of debris.

3. The air intake system of claim 2, wherein the second ambient air contains a second amount of debris, the second amount of debris lower than the first amount, the screen blocking the passage of some debris from the first amount.

4. The air intake system of claim 3, wherein the third ambient air contains a third amount of debris, the third amount of debris lower than the second amount, a portion of the second amount of debris unable to change direction sufficiently to move into the channel inlet.

5. The air intake system of claim 4, wherein the fourth ambient air contains a fourth amount of debris, the fourth amount of debris lower than the third amount, the filter blocking the passage of some debris from the third ambient air.

6. The air intake system of claim 1, wherein the at least one side wall includes two sidewalls.

7. The air intake system of claim 6, wherein the engine enclosure further comprises a floor.

8. The air intake system of claim 1, wherein the air intake duct comprises metal walls.

9. The air intake system of claim 8, wherein the air channel includes heat insulation significantly reducing heat transfer from the engine enclosure to the third ambient air.

10. The air intake system of claim 9, wherein the heat insulation comprises a plurality of metal walls, the plurality of metal walls forming an inner duct structure and an outer duct structure and having a gap of predetermined width between the inner and outer duct structures as well as substantially static air within the gap.

11. An air intake system for powered machinery comprising:
an engine enclosure, the engine enclosure comprising a hood and at least one side wall;
an engine;
a screen;
a filter; and
a fan, the hood including an air intake duct along a length of the hood, the air intake duct integral to the hood and supplying intake air for the engine, the air intake duct having an entrance passage providing for the entrance of air flowing in a direction substantially orthogonal to a direction of the air intake duct, the entrance passage longitudinally located between the screen and the engine, the fan moving a first ambient air through the screen, the fan moving a second ambient air from the screen into the engine enclosure, the engine moving a third ambient air through the entrance passage and into the air intake duct via an air intake duct pressure lower than a pressure of the second ambient air, the engine moving the third ambient air through the filter via the channel pressure to provide a fourth ambient air.
